(19) United States
(12) Patent Application Publication
(10) Pub. No.: US 2013/0282846 A1
(43) Pub. Date: Oct. 24, 2013

(54) SYSTEM AND METHOD FOR PROCESSING SIMILAR EMAILS

(71) Applicant: TENCENT TECHNOLOGY (SHENZHEN) COMPANY LIMITED, Shenzhen (CN)

(72) Inventors: HUI WANG, Shenzheng (CN); HUASHANG LIN, Shenzhen (CN)

(21) Appl. No.: 13/905,037

(22) Filed: May 29, 2013

Related U.S. Application Data
(63) Continuation of application No. PCT/CN2012/070816, filed on Feb. 1, 2012.

(30) Foreign Application Priority Data
Mar. 3, 2011 (CN) 201110051222.2

(51) Int. Cl. H04L 12/58

(52) U.S. Cl. CPC H04L 51/00
USPC 709/206

(57) ABSTRACT

Embodiments of the present invention disclose a system and a method for processing similar emails, and relate to the field of web technologies. The system includes: a control node, configured to receive a sample of a preset format, and determine whether the sample of preset format is a final result of similarity computing; if not, combine or split the sample of preset format according to a preset criterion to obtain multiple subtask packets, and allocate the multiple subtask packets to multiple similarity computing nodes; and multiple similarity computing nodes, configured to: compute similarity relationships for the samples in received subtask packets to obtain an intermediate similarity computing result that is a sample in the preset format, and feed back the sample in the preset format to the control node, where the intermediate similarity computing result includes a unique similar sample, a similarity relationship, and similarity count of unique similar sample.

### CROSS-REFERENCE TO RELATED APPLICATIONS

This application is a continuation of International Application No. PCT/CN2012/070816, filed Feb. 1, 2012, which claims priority to Chinese Patent Application No. 201110051222.2, filed on Mar. 3, 2011, both of which are hereby incorporated by reference in their entireties.

### FIELD OF THE INVENTION

The present invention relates to the field of web technologies, and in particular, to a system and a method for processing similar emails.

### BACKGROUND OF THE INVENTION

With development of the Internet, emails become an important tool of communication in people's everyday life. However, spams constantly increase and bring inconvenience to the users. In the prior art, an anti-spam system based on a text similarity technology is applied, and a mature mechanism is provided for making statistics until the spams are intercepted. Such a system is primarily based on a stand-alone computing mode, and can obtain statistics on a considerable number of emails in a short time and obtain similarity relationships between the emails as well as a similarity index. The system can identify spams that have transformed to some extent and spams in which interfering elements are added. In practical application, therefore, the system performs excellently in intercepting spams in terms of size, quantity and accuracy.

After analyzing the prior art, the inventor of the present invention finds at least the following defects in the prior art:

The system for processing similar emails in the prior art is based on a stand-alone computing mode, and is rather limited in terms of the processible size of input data and output data. For the input data that surges in a magnitude of millions or more at a time, the computing speed is low, the system load is high, the processing is not in real time, and even quasi-real-time statistics are hardly achievable due to too much consumption of time.

### SUMMARY OF THE INVENTION

Embodiments of the present invention provide a system and a method for processing similar emails. The technical solutions are as follows:

A system for processing similar emails includes:

a control node, configured to: receive samples of a preset format, and determine whether the samples of the preset format are a final result of similarity computing; if not, combine or split the samples of the preset format according to a preset criterion to obtain multiple subtask packets, and allocate the multiple subtask packets to multiple similarity computing nodes; and

multiple similarity computing nodes, configured to: compute a similarity relationship for the sample in the received subtask packet to obtain an intermediate similarity computing result which is in a preset format, and feed back the intermediate similarity computing result to the control node, where the intermediate similarity computing result includes at least a unique similar sample, a similarity relationship, and a similarity count of the unique similar sample.

The system further includes:

a data input node, configured to collect original samples, convert each original sample into a preset format, and send the converted original sample packet as a sample of the preset format to the control node.

The data input node includes:

a data collecting module, configured to collect emails on a server or a server cluster of a similar email processing system, and use the emails as original samples;

a converting module, configured to convert the original sample into a preset format which matches similarity computing; and

a sending module, configured to allocate a task identifier to a converted original sample packet, and send the packet of the converted original sample as a sample of the preset format to the control node in whole or in batches.

The sending module includes:

an optimized transmission unit, configured to split the packet of the converted original sample into multiple packets according to network conditions; and

a sending unit, configured to send the multiple packets, which are output by the optimized transmission unit, as samples of the preset format to the control node in batches.

The control node includes:

a receiving module, configured to receive the sample of the preset format;

a determining module, configured to: determine whether the sample of the preset format meets preset conditions; if yes, determine that the sample of the preset format is a final result of similarity computing; if no, determine that the sample of the preset format is not a final result of similarity computing, and trigger a combining or splitting module;

the combining or splitting module, configured to combine or split the sample of the preset format according to heartbeat information of the similarity computing node to obtain multiple subtask packets, where the heartbeat information is used to monitor and describe an idle computing power of the similarity computing node; and

an allocating module, configured to allocate the multiple subtask packets obtained by the combining or splitting module to each similarity computing node respectively.

The combining or splitting module is specifically configured to obtain statistics on key data indicators of the converted original sample packet and the sample of the preset format, sort the packet of the converted original sample and the sample of the preset format according to configuration file registration information and the key data indicators, and combine or split the packet of the converted original sample and the sample of the preset format according to sorting order to obtain multiple subtask packets.

The control node further includes:

a heartbeat information monitoring module, configured to obtain heartbeat information of the similarity computing node at preset intervals or upon receiving a sample of the preset format.

The control node is further configured to save and record the samples of the preset format, record mapping relationships between the multiple subtask packets and the similarity computing nodes to which the subtask packets are allocated, and record the heartbeat information of the similarity computing nodes.

The heartbeat information monitoring module is further configured to: if the similarity computing node returns no heartbeat information within a preset duration and keeps returning no heartbeat information for more than a preset number of consecutive times, mark the similarity computing node as crashed, mark subtask packets active on the similarity computing node as failed, and trigger the allocating module to allocate the subtask packets marked as failed to uncrashed and idle similarity computing nodes according to the heartbeat information of the similarity computing node.

A method for processing similar emails includes:

receiving an original sample and a sample of a preset format, and converting the received original sample into the preset format;

determining whether a converted original sample packet and the sample of the preset format are a final result of similarity computing;

if not, combining or splitting the converted original sample packet and the sample of the preset format according to a preset criterion to obtain multiple subtask packets; and

computing a similarity relationship for a sample in each subtask packet to obtain an intermediate similarity computing result which is a sample of the preset format, and feeding back the sample of the preset format, where the intermediate similarity computing result includes at least a unique similar sample, a similarity relationship, and similarity count of the unique similar sample.

The receiving the original sample and the sample of the preset format comprises:

collecting emails on a server or a server cluster of a similar email processing system, using the emails as original samples, and allocating task identifiers to the original samples; and

determining whether a task participated in by a sample of the preset format is complete according to the task identifier of the sample of the preset format; if not, aggregating the sample of the preset format with other samples of the task participated in.

The determining whether a converted original sample packet and the sample of the preset format are a final result of similarity computing comprises:

determining whether the converted original sample packet meets preset conditions; if the converted original sample packet meets the preset conditions, determining that the converted original sample packet is a final result of similarity computing; if the converted original sample packet does not meet the preset conditions, determining that the the converted original sample packet is not a final result of similarity computing; and

determining whether the sample of the preset format meets preset conditions; if the sample of the preset format meets the preset conditions, determining that the sample of the preset format is a final result of similarity computing; if the sample of the preset format does not meet the preset conditions, determining that the sample of the preset format is not a final result of similarity computing.

The combining or splitting the converted original sample packet and the sample of the preset format according to a preset criterion to obtain multiple subtask packets comprises:

obtaining statistics on key data indicators of the converted original sample packet and the sample of the preset format, sorting the packet of the converted original sample and the sample of the preset format according to configuration file registration information and the key data indicators, and combining or splitting the packet of the converted original sample and the sample of the preset format according to sorting order to obtain multiple subtask packets, where

if the sample of the preset format has undergone similarity computing for at least one time and a local server stores at least two samples of the preset format returned by a task participated in by the sample of the preset format, a combining action needs to be performed for the at least two samples of the preset format returned by the task participated in by the sample of the preset format.

The preset criterion includes at least any one of the following:

splitting the packet of the converted original sample if number of records in the packet of the converted original sample or a total number of bytes in the packet exceeds a preset threshold; and

splitting the sample of the preset format if number of records in the sample of the preset format or a total number of bytes in the sample which is packetized exceeds a preset threshold.

The technical solutions of the present invention bring the following benefits:

In a distributed system, the control node combines or splits input samples, and allocates obtained multiple subtask packets to multiple similarity computing nodes. The distributed system processes and computes more than tens of millions of similar emails, thereby improving the computing speed and computing power, reducing system loads, and fulfilling anti-spam requirements such as real-time and quasi-real-time statistics and interception.

### BRIEF DESCRIPTION OF THE DRAWINGS

To illustrate the technical solutions in embodiments of the present invention or in the prior art more clearly, the following briefly describes the accompanying drawings required for describing the embodiments or the prior art. Apparently, the accompanying drawings in the following description merely show some embodiments of the present invention, and persons of ordinary skill in the art can derive other drawings from these drawings without creative efforts.

FIG. 1a is a schematic diagram of a system for processing similar emails according to an embodiment of the present invention;

FIG. 1b is a schematic diagram of a system for processing similar emails according to an embodiment of the present invention;

FIG. 2 is a flowchart of a method for processing similar emails according to an embodiment of the present invention; and

FIG. 3 is a flowchart of a method for processing similar emails according to an embodiment of the present invention.

### DETAILED DESCRIPTION OF THE EMBODIMENTS

To make the technical solutions and advantages of the present invention more comprehensible, the following describes embodiments of the present invention in more detail with reference to accompanying drawings.

Before the system for processing similar emails in according to embodiments of the present invention is described, fundamental knowledge concerning embodiments of the present invention is outlined first:

Embodiments of the present invention are based on the following simple common knowledge: spams are large in number and in size, and are similar in form. Apparently, if our processing and computing speed is fast enough, spams (in large numbers) can be identified at the earliest possible time and then intercepted. Therefore, the sooner the large numbers of similar spams are discovered, the sooner the spams are coped with and prevented from entering the mailbox system (according to statistics, more than 60% of emails in a mailbox system are spams). That benefits the user evidently, and also slashes operation costs (in bandwidth and storage).

### Embodiment 1

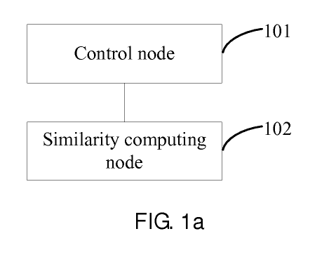

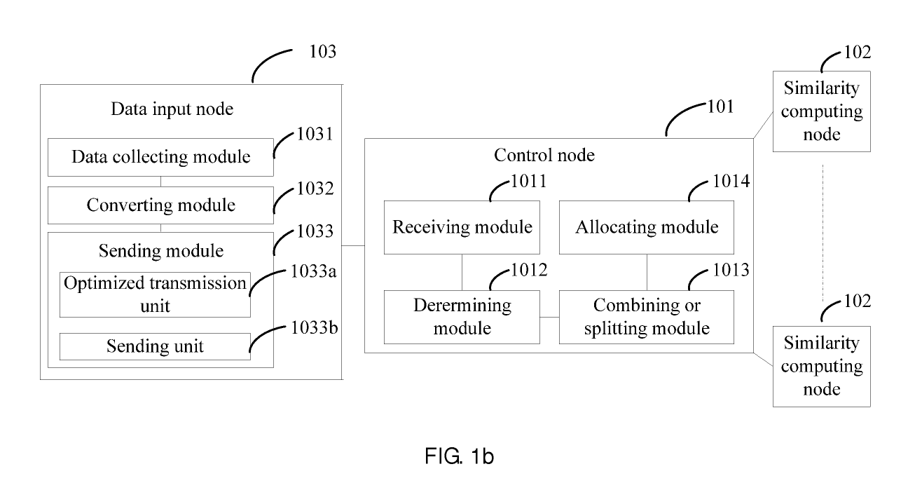

To improve the computing speed and computing power and reduce system loads, an embodiment of the present invention provides a system for processing similar emails. As shown in FIG. 1a, the system includes a control node 101 and multiple similarity computing nodes 102.

The control node 101 is configured to: receive samples of a preset format, and determine whether the samples of the preset format are a final result of similarity computing; if not, combine or split the samples of the preset format according to a preset criterion to obtain multiple subtask packets, and allocate the multiple subtask packets to multiple similarity computing nodes.

The multiple similarity computing nodes 102 are configured to: compute similarity relationships for the samples in the received subtask packets to obtain an intermediate similarity computing result that is a sample of the preset format, and feed back the sample of the preset format to the control node, where the intermediate similarity computing result includes at least a unique similar sample, a similarity relationship, and a similarity count of the unique similar sample.

As shown in FIG. 1b, the system further includes:

a data input node 103, configured to collect original samples, convert each original sample into the preset format, and send a converted original sample packet as a sample of the preset format to the control node.

The data input node 103 includes:

a data collecting module 1031, configured to collect emails on a server or a server cluster of a similar email processing system, and use the emails as the original samples;

a converting module 1032, configured to convert the original sample into the preset format that matches similarity computing; and

a sending module 1033, configured to allocate a task identifier to a converted original sample packet, and send the converted original sample packet as a sample of the preset format to the control node in whole or in batches.

The sending module 1033 includes:

an optimized transmission unit 1033a, configured to split the converted original sample packet into multiple packets according to network conditions; and

a sending unit 1033b, configured to send the multiple packets, which are output by the optimized transmission unit, as samples of the preset format to the control node in batches.

The control node 101 includes:

a receiving module 1011, configured to receive the sample of the preset format;

a determining module 1012, configured to: determine whether the sample of the preset format meets preset conditions; if yes, determine that the sample of the preset format is a final result of similarity computing; if no, determine that the sample of the preset format is not a final result of similarity computing, and trigger a combining or splitting module;

the combining or splitting module 1013, configured to combine or split the sample of the preset format according to heartbeat information of the similarity computing node to obtain multiple subtask packets, where the heartbeat information is used to describe an idle computing power of the similarity computing node, where

the combining or splitting module 1013 is specifically configured to obtain statistics on key data indicators of the converted original sample packet and the sample of the preset format, sort the converted original sample packet and the sample of the preset format according to configuration file registration information and the key data indicators, and combine or split the packet of the converted original sample and the sample of the preset format according to sorting order to obtain multiple subtask packets; and

an allocating module 1014, configured to allocate the multiple subtask packets obtained by the combining or splitting module to each similarity computing node 102 respectively.

The control node 101 further includes:

a heartbeat information monitoring module, configured to obtain heartbeat information of the similarity computing node at preset intervals or upon receiving a sample of the preset format.

The control node 101 is further configured to save and record the sample of the preset format, record mapping relationships between the multiple subtask packets and the similarity computing nodes to which the subtask packets are allocated, and record the heartbeat information of the similarity computing nodes.

The heartbeat information monitoring module is further configured to: if the similarity computing node returns no heartbeat information within a preset duration and keeps returning no heartbeat information for more than a preset number of consecutive times, mark the similarity computing node as crashed, mark subtask packets active on the similarity computing node as failed, and trigger the allocating module to allocate the subtask packets marked as failed to uncrashed and idle similarity computing nodes according to the heartbeat information of the similarity computing node.

In a distributed system, the control node combines or splits input samples, and allocates obtained multiple subtask packets to multiple similarity computing nodes. The distributed system implements similarity processing and computing for more than tens of millions of emails, so as to improve the computing speed and computing power, reduce system loads, and fulfill anti-spam requirements such as real-time and quasi-real-time statistics and interception.

### Embodiment 2

To improve the computing speed and computing power and reduce system loads, an embodiment of the present invention provides a method for processing similar emails. The entity for performing the method is the system for processing similar emails in Embodiment 1.

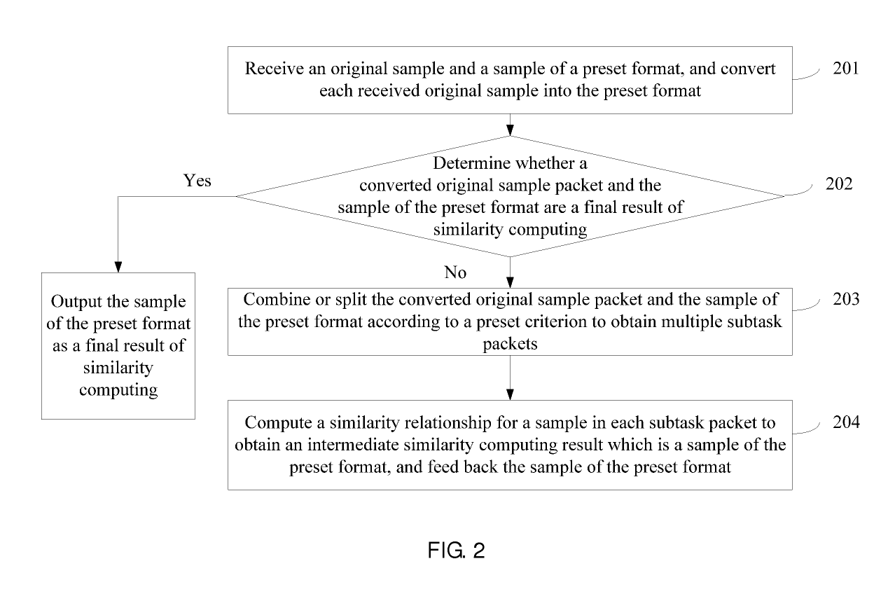

As shown in FIG. 2, the method includes:

201. The system for processing similar emails receives an original sample and a sample of a preset format, and converts the received original sample into the preset format.

202. The system for processing similar emails determines whether converted original sample packet and the sample of the preset format are a final result of similarity computing.

203. If no, combine or split the converted original sample packet and the sample of the preset format according to a preset criterion to obtain multiple subtask packets.

If yes, determine that the sample of the preset format is a final result of similarity computing, and output the sample of the preset format as the final result of similarity computing.

204. The system for processing similar emails computes a similarity relationship for a sample in each subtask packet to obtain an intermediate similarity computing result which is a sample of the preset format, and feeds back the sample of the preset format, where the intermediate similarity computing result includes a unique similar sample, a similarity relationship, and similarity count of the unique similar sample.

The receiving the original sample and the sample of the preset format include:

collecting emails on a server or a server cluster of a similar email processing system, using the emails as original samples, and allocating task identifiers to the original samples; and

determining whether a task participated in by a sample of the preset format is complete according to the task identifier of the sample of the preset format; if not, aggregating the sample of the preset format with other samples of the task participated in.

The determining whether a packet of the converted original sample and the sample of the preset format are a final result of similarity computing comprises:

determining whether the converted original sample packet meets preset conditions; if the converted original sample packet meets the preset conditions, determining that the converted original sample packet is a final result of similarity computing; if the converted original sample packet does not meet the preset conditions, determining that the converted original sample packet is not a final result of similarity computing; and

determining whether the sample of the preset format meets preset conditions; if the sample of the preset format meets the preset conditions, determining that the sample of the preset format is a final result of similarity computing; if the sample of the preset format does not meet the preset conditions, determining that the sample of the preset format is not a final result of similarity computing.

The combining or splitting the converted original sample packet and the sample of the preset format according to a preset criterion to obtain multiple subtask packets comprises:

obtaining statistics on key data indicators of the converted original sample packet and the sample of the preset format, sorting the converted original sample packet and the sample of the preset format according to configuration file registration information and the key data indicators, and combining or splitting the converted original sample packet or the sample of the preset format according to sorting order to obtain multiple subtask packets, where

if the sample of the preset format has undergone similarity computing for at least one time and a local server stores at least two samples of the preset format returned by a task participated in by the sample of the preset format, a combining action is performed on the at least two samples of the preset format returned by the task participated in by the sample of the preset format.

The preset criterion includes at least any one of the following:

splitting the converted original sample packet if number of records in the converted original sample packet exceeds a preset threshold;

splitting the converted original sample packet if number of records in the packet of the converted original sample or a total number of bytes in the packet exceeds a preset threshold; and

splitting the sample of the preset format if number of records in the sample of the preset format or a total number of bytes in the sample that is packetized exceeds a preset threshold.

The method provided in the embodiment of the present invention is based on the same conception as the system embodiment. For detailed implementation process of the method, refer to the system embodiment, and no more tautology here..

In a distributed system, the control node combines or splits input samples, and allocates obtained multiple subtask packets to multiple similarity computing nodes. The distributed system implements similarity processing and computing for more than tens of millions of emails, thereby improving the computing speed and computing power, reducing system loads, and fulfilling anti-spam requirements such as real-time and quasi-real-time statistics and interception.

### Embodiment 3

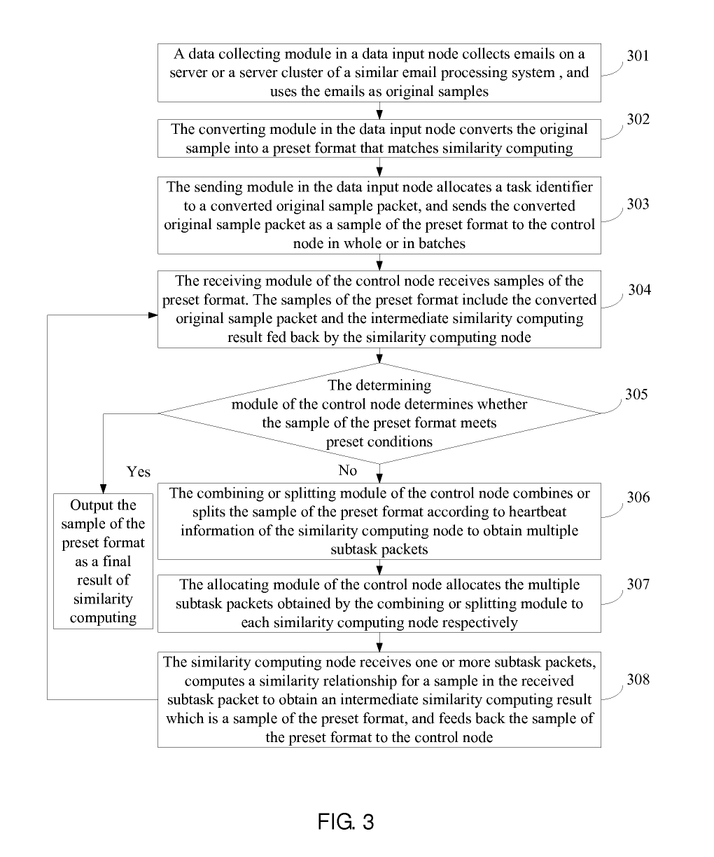

To improve the computing speed and computing power and reduce system loads, an embodiment of the present invention provides a method for processing similar emails. The entities for performing the method are different nodes in the system for processing similar emails in Embodiment 1. The system for processing similar emails includes a data input node, a control node, and a similarity computing node. In this embodiment, it is assumed that the system for processing similar emails includes a data input node, a control node, and 4 similarity computing nodes. Note that the control node may receive an original sample and convert the original sample, or receive samples from the data input node and let the data input node convert them. In the embodiment of the present invention, it is assumed that the data input node perform the conversion. As shown in FIG. 3, the method in the embodiment of the present invention includes the following steps:

301. A data collecting module in a data input node collects emails on a server or a server cluster of a similar email processing system, and uses the emails as original samples.

The data input node is configured to collect original samples, convert the original sample into a preset format, and send a converted original sample packet as a sample of the preset format to the control node.

Those skilled in the art understand that the data input node may be a server capable of communicating with the control node, or a server cluster made up of multiple servers.

302. The converting module in the data input node converts the original sample into a preset format that matches similarity computing.

Note that in subsequent similarity computing, to enhance processing speed and facilitate recording of processing results, the original sample needs to be converted into a data format corresponding to a similarity computing algorithm according to the similarity computing algorithm configured on a subsequent similarity computing node. The similarity computing algorithm comes in many types, and is not defined herein.

303. The sending module in the data input node allocates a task identifier to a converted original sample packet, and sends the converted original sample packet as a sample of the preset format to the control node in whole or in batches.

The task identifier is allocated to make an active task in the system transparent. Through the task identifier, a technician can know which tasks are currently active in the system. To abort a task, the control node may send, according to the task identifier, an abort command to the similarity computing node which is running a subtask of the task.

Optionally, whether a task participated in by a sample of the preset format is complete is determined according to the task identifier of the sample of the preset format; if not, the sample of the preset format is aggregated with other samples of the task participated in.

Specifically, when the size of the original sample exceeds a specific value such as 1G, the optimized transmission unit in the sending module splits the converted original sample packet into multiple packets according to network conditions; and the sending unit sends the multiple packets, which are output by the optimized transmission unit, as samples of the preset format to the control node in batches. In this way, less memory and bandwidth resources are occupied.

Note that the data input node may be a part of the control node. The format conversion function of the data input node may also be performed by the control node instead. When the control node includes this function, the data input node is responsible for collecting an email, and packetizing and sending the email as an original sample to the control node. After receiving the original sample, the control node scans the original sample, and converts the original sample into a sample of the preset format. After the determination in step 305 is made, if the sample of the preset format is not a final result of similarity computing, the control node obtain statistics on key data indicators (including size of a packet or number of records in the packet) of the preset format, sorts the packet according to sample configuration information (including number of records in each packet or size of each packet) and the key data indicators, and splits or combines the sorted packet into multiple subtask packets. The above steps are processing of the original sample.

304. The receiving module of the control node receives samples of the preset format. The samples of the preset format include the converted original sample packet and the intermediate similarity computing result fed back by the similarity computing node.

The control node is configured to: receive a sample of a preset format, and determine whether the sample of the preset format is a final result of similarity computing; if not, combine or split the sample of the preset format according to a preset criterion to obtain multiple subtask packets, and allocate the multiple subtask packets to multiple similarity computing nodes.

Depending on their sources and processing steps undergone, the samples of the preset format in subsequent steps may be categorized into packets of original samples that are converted by the data input node and samples of the preset format that are not converted by the data input node. For the control node, all data received by the control node is in the preset format. Therefore, in subsequent steps, it does not make a distinction between the converted original sample packets and the samples of the preset format, and the the converted original sample packets and the samples of the preset format are uniformly called samples of the preset format.

Note that the samples are received in two scenarios:

1. All samples are input at a single attempt, a lifecycle of a task is ended upon completion of computing similarity of current input data, and a similarity relationship covers only currently input samples.

2. The samples are transmitted in separate batches, and the lifecycle of the task is long or endless. The similarity relationship data to be output needs to cover all input data, and the similarity results of samples, whose transmission has been completed, can be output without waiting for completion of transmitting all samples before a similarity computing process is started.

Note that the control node is a control part of an entire system. The control node is further configured to process a request from the data input node. In this embodiment, the request is a request for similarity computing for the samples of the preset format. To ensure security, the control node may verify whether the request is legal. If the request is verified as legal, the control node processes the received sample of the preset format. The control node is generally one server, or, in a case of hot backup, may be two or more servers.

Further, the control node is further configured to save and record the sample of the preset format, record mapping relationships between the multiple subtask packets and the similarity computing nodes to which the subtask packets are allocated, and record the heartbeat information of the similarity computing nodes.

305. The determining module of the control node determines whether the sample of the preset format meets preset conditions.

If yes, determine that the sample of the preset format is a final result of similarity computing, and output the sample of the preset format as the final result of similarity computing.

If no, determine that the sample of the preset format is not a final result of similarity computing, and proceed to step 306.

The preset conditions are: similarity count of the sample reaches a preset threshold and the sample packet is already filtered with independent samples eliminated, where independent samples refer to samples similar to no other samples; or, no new similarity relationship is discovered after similarity computing, for example, after 1000 samples are input and computed, no combinable sample is discovered, and there are still 1000 samples.

The preset conditions are set by a technician according to bearing capacity of the system or other factors, and are not specifically defined in the embodiment of the present invention.

In an embodiment, when a sample of the preset format is a converted original sample packet, the records in the converted original sample packet vary sharply between each other, and no similarity computing is required. In this case, the converted original sample packet can be used as a final result of similarity computing.

306. The combining or splitting module of the control node combines or splits the sample of the preset format according to heartbeat information of the similarity computing node to obtain multiple subtask packets.

The heartbeat information is used to monitor and describe idle computing power of the similarity computing node, including the configuration and computing power of the node's CPU or memory, and a list of currently active tasks. The heartbeat information monitoring module is configured to obtain heartbeat information of the similarity computing node at preset intervals or upon receiving a sample of the preset format. Specifically, the heartbeat information monitoring module sends a heartbeat information request to the similarity computing node at preset intervals (such as every 1 minute); or, when the control node receives a sample of the preset format, the control node triggers the heartbeat information monitoring module to send a heartbeat information request to the similarity computing node. When receiving the heartbeat information request, the similarity computing node feeds back information such as a list of currently active subtasks to the control node. The heartbeat information monitoring module saves the heartbeat information fed back, monitors all similarity computing nodes regularly, and monitors active subtask status, including “active”, “complete” or “aborted” and so on, which is available for query in allocating subtask packets and in a case that the similarity computing node crashes.

Note that a TCP long link is kept between the control node and all similarity computing modules.

Further, in the embodiment of the present invention, the sample of the preset format is split if number of records in the sample of the preset format exceeds a preset threshold or a total number of bytes in the packetized sample exceeds a preset threshold. Specifically, a sample needs to be split if the sample of the preset format must meet any one of the following conditions:

1. the sample is already sorted according to key data indicators;

2. the number of records exceeds a preset threshold such as 100 thousands; and

3. the size of the packet exceeds a preset threshold such as 1G after the sample is packetized into the packet.

Further, in the embodiment of the present invention, if a sample must meet any one of the following conditions, the sample needs to be combined:

1. after the sample is sorted, similar records occur only in a continuous range of the key data indicator, or occur at a high probability;

2. after similarity computing is performed according to the key data indicator and a step of making the sample unique (that is, only one sample is retained, but the similarity indexes between all combined samples and the only sample are recorded) is performed, the sample keeps unchanged; and

3. in a lifecycle of a task identifier, if there are multiple and slow submissions of original data s and, it is sure that the similarity of a part of samples has been computed; or, the data amount is large, multiple subtask packets need to be distributed at a time, and the corresponding similarity computing result needs to be received, when the sample of the preset format has undergone similarity computing for at least one time and a local server stores at least two samples of the preset format returned by a task participated in by the sample of the preset format, a combining action needs to be performed for the at least two samples of the preset format returned by the task participated in by the sample of the preset format.

Note that at a later stage of the combining operation, the total number of unique similar samples may be still huge. In this case, if the above method is repeated, an endless loop of splitting and combining will occur. When the number of unique similar samples exceeds a preset threshold, in order to avoid endless loop, actions may be taken according to different situations, as detailed below:

1. discard the samples with a small similarity count. For example, discard all samples whose similarity count is less than 5;

2. if no similarity relationship exists between samples in a subtask packet after a similarity computing process, the subtask packet is marked as reaching final computing status and will not participate in the subsequent combining or splitting process until new input data corresponding to this task identifier is transmitted and sorted within data range of this subtask packet;

3. with increasing number of times of computing undergone, the discard threshold should increase gradually; and

4. when all subtasks reach final status or the number of times of computing undergone reaches a threshold, the data will not participate in a next computing process any more, and such original input data is marked as being completely computed, and the similarity computing task is complete.

307. The allocating module of the control node allocates the multiple subtask packets obtained by the combining or splitting module to each similarity computing node respectively.

Those skilled in the art understand that, the allocation of in step 305 already allows for the computing power of each similarity computing node. Therefore, the size of the packet received by each similarity computing node and the number of included records may vary.

Note that, if the current similarity computing node is unable to process all subtask packets, a part of the subtask packets may be allocated first, and the remaining subtask packets are allocated when the heartbeat information of the similarity computing node shows that the similarity computing node is idle. One or more subtask packets may be allocated to one similarity computing node.

308. The similarity computing node receives one or more subtask packets, computes a similarity relationship for a sample in the received subtask packet to obtain an intermediate similarity computing result which is a sample of the preset format, and feeds back the sample of the preset format to the control node, whereupon step 304 is performed until the task participated in by the sample is complete.

Further, when receiving a sample of the preset format, the control node determines, according to a task identifier of the sample, whether all subtask packets in the task participated in by the sample are already fed back; if yes, the task is complete; if no, the control node combines or splits the sample of the preset format fed back and subsequently input samples again, and then allocates the combined or split sample to the similarity computing node for similarity computing again.

The intermediate similarity computing result includes at least a unique similar sample, a similarity relationship, and similarity count of the unique similar sample, and may further include other information. The similarity relationship is a similarity index between samples. For example, if sample A is not similar to sample B, their similarity relationship is Sim (A, B)=0.

In the embodiment of the present invention, the similarity computing node is responsible only for computing similarity of internal records in each packet and feeding back the intermediate similarity computing result of each packet to the control node, but without processing the packets. The computing node unit is responsible for specific similarity computing tasks, and data input and output, without changing the original data.

The similarity computing nodes may be servers that have different CPU computing powers, and may use one or more core algorithms of similarity computing.

Preferably, to avoid too much complexity of system information, the similarity computing node does not report its heartbeat information proactively, but returns necessary information to the control node upon receiving a heartbeat information request.

Preferably, each task is limited by a maximum running duration. That is, if the running time of a task exceeds a specified number of seconds, the task becomes invalid. At this time, only a part of similar samples have finished similarity computing, and, depending on configuration information of the subtask, whether to return unfinished results to the control node is determined If an abort command is received from the control node in the process of running a subtask, the running will be stopped and discarded immediately. When the running of the subtask is complete, the similarity computing node sends a request to the control node to return result data. A mechanism of reattempt upon timeout is available. That is, when the request sent by the similarity computing node is not responded to by the control node in a preset duration, the request is sent again. When the number of re-sending the request exceeds a preset value, the control node is regarded as crashed. In a case that a similarity computing node crashes, the data in the similarity computing node and unfinished subtasks will not be recovered. After the similarity computing node restores responding, it waits for new computing requests.

The following gives a simplified instance to show how to obtain complete similarity relationships between massive original input samples:

The original input samples include 9 samples: A, B, C, D, E, F, U, H, and I. They are sorted according to key data indicators, and then split into 3 packets that are listed below:

| | | | |
|---|---|---|---|
| Packet 1 | A | B | C |
| Packet 2 | D | E | F |
| Packet 3 | G | H | I |

After a first round allocation and sample feedback, the following results are obtained:

| Packet | Similarity relationship | Similarity count |
|---|---|---|
| Packet 1 | S(B, A) = 0.9 | count(A) = 3 |
| | S(C, A) = 0.7 | |
| Packet 2 | S(E, D) = 0.8 | count(D) = 3 |
| | S(F, D) = 1 | |
| Packet 3 | S(H, G) = 0.66 | count(G) = 3 |
| | S(I, G) = 1 | |

All the 3 subtasks are finished and results are returned, and a second round of allocation is ready. Due to small data amount, the combined packet needs no more splitting:

| | | | |
|---|---|---|---|
| Packet 4 | A | D | G |

After this packet is allocated as a new subtask, the following result is obtained:

| | | |
|---|---|---|
| Packet 4 | S(D, A) = 0.9 | count(A) = 6 |
| | G | count(G) = 3 |

A letter G alone represents that no similar sample. Because there is only one packet and the computing is complete, the processing of the request is complete. At this time, the sorted unique similar samples and all similarity relationships are as follows:

| Sample list | Sample count | Similarity relationship |
|---|---|---|
| A | count(A) = 6 | S(B, A) = 0.9 |
| G | Count(G) = 3 | S(C, A) = 0.7 |
| | | S(E, D) = 0.8 |
| | | S(F, D) = 1 |
| | | S(H, G) = 0.66 |
| | | S(I, G) = 1 |
| | | S(D, A) = 0.9 |

The above result is recorded in a disk file or database for future reference. The whole processing process is complete.

In practical running, a similarity computing node may crash. If the similarity computing node returns no heartbeat information within a preset duration and keeps returning no heartbeat information for more than a preset number of consecutive times, it is appropriate to mark the similarity computing node as crashed, mark the subtask packets active on the similarity computing node as failed, and trigger the allocating module to allocate the subtask packets marked as failed to uncrashed and idle similarity computing nodes according to the heartbeat information of the similarity computing node. The following gives an example.

In the embodiment of the present invention, the system for processing similar emails includes one control node and 4 similarity computing nodes. The 4 similarity computing nodes are Node 1, Node 2, Node 3, and Node 4. Active subtask packets are P1, P2, P3, and P4, and the subtask packets active on the similarity computing nodes are shown in Table 1 below.

TABLE 1

Node

| | Node1 | Node2 | Node3 | Node4 |
|---|---|---|---|---|
| Task | P1, P2 | P3 | P4 | — |

The control node sends a heartbeat information request to the 4 similarity computing nodes, and the obtained heartbeat information is shown in Table 2 below.

TABLE 2

| | Node | | | |
|---|---|---|---|---|
| | Node1 | Node2 | Node3 | Node4 |
| Status | Currently running | — | P4 running is complete | Idle |
| | P1 and P2 | | | |

Among the nodes, Node 2 feeds back no heartbeat information within the preset duration, and Node 2 still feeds back no heartbeat information after the number of times of requesting exceeds the preset threshold. Therefore, Node 2 is regarded as crashed, and tasks active on Node 2 are searched out in Table 3 which shows previous normal heartbeat information:

TABLE 3

| | Node | | | |
|---|---|---|---|---|
| | Node1 | Node2 | Node3 | Node4 |
| Status | Currently running | Currently | Currently | Idle |
| | P1 and P2 | running P3 | running P4 | |

As indicated in Table 3, Node 2 is running P3 when it crashes; Table 2 shows that Node 4 is idle, and Node 3 has finished running Among Node 4 and Node 3, the computing power of Node 3 is higher, but the data amount of P3 is large. Therefore, P3 is allocated to Node 3 for similarity computing again.

In practical running, the control node may crash. Normally, the control node regularly stores a subtask information list through LOG Through comparison with a restructured subtask list, the control node can find the subtasks ready for allocating and the part of subtasks which are unsuccessfully allocated at the time of crash, so as to recover rough status as it is before the crash. That includes a scenario that the similarity computing node runs normally when the control node crashes. In this scenario, all computing result requests sent by the similarity computing node in a short time suffer timeout. However, with a mechanism of reattempting until success, subtask information and data already allocated remain complete. After the control node recovers its service, the requests sent by the similarity computing node will be received and processed properly. Besides, upon recovery and startup, the control node uses a heartbeat service to collect information on subtasks which are running at the moment. A list of subtasks can be restructured according to the LOG data of the control node. Note that in extreme circumstances, it is possible that some information is lost. The lost information may be the part for which the similarity computing request has been received but the packet has not been split, or the part for which the packet has been split but not allocated.

In a distributed system, the control node combines or splits input samples, and allocates obtained multiple subtask packets to multiple similarity computing nodes. The distributed system implements similarity processing and computing for more than tens of millions of emails, thereby improving the computing speed and computing power, reducing system loads, and fulfilling anti-spam requirements such as real-time and quasi-real-time statistics and interception.

All or part of the foregoing technical solutions provided in the embodiments of the present invention may be implemented by a program instructing relevant hardware. The program may be stored in a readable storage medium. The storage medium may be a ROM, RAM, magnetic disk, optical disk, or any type of media suitable for storing program codes.

The above descriptions are merely preferred embodiments of the present invention, but are not intended to limit the scope of the present invention. Any modifications, replacement or improvement that can be easily derived by those skilled in the art without departing from the spirit and principles of the present invention shall fall within the protection scope of the present invention.

What is claimed is:

1. A system for processing similar emails, comprising:
a control node, configured to: receive samples of a preset format, and determine whether the samples of the preset format are a final result of similarity computing; if not, combine or split the samples of the preset format according to a preset criterion to obtain multiple subtask packets, and allocate the multiple subtask packets to multiple similarity computing nodes; and
multiple similarity computing nodes, configured to: compute a similarity relationship for the sample in the received subtask packet to obtain an intermediate similarity computing result which is in a preset format, and feed back the intermediate similarity computing result to the control node, wherein the intermediate similarity computing result comprises at least a unique similar sample, a similarity relationship, and a similarity count of the unique similar sample.

2. The system according to claim 1, further comprising:
a data input node, configured to collect original samples, convert each original sample into a preset format, and send a converted original sample packet as a sample of the preset format to the control node.

3. The system according to claim 2, wherein the data input node comprises:
a data collecting module, configured to collect emails on a server or a server cluster of a similar email processing system, and use the emails as original samples;
a converting module, configured to convert the original sample into a preset format which matches similarity computing; and
a sending module, configured to allocate a task identifier to a converted original sample packet, and send the packet of the converted original sample as a sample of the preset format to the control node in whole or in batches.

4. The system according to claim 3, wherein the sending module comprises:
an optimized transmission unit, configured to split the converted original sample packet into multiple packets according to network conditions; and
a sending unit, configured to send the multiple packets, which are output by the optimized transmission unit, as samples of the preset format to the control node in batches.

5. The system according to claim 1, wherein the control node comprises:
a receiving module, configured to receive the sample of the preset format;
a determining module, configured to: determine whether the sample of the preset format meets preset conditions; if yes, determine that the sample of the preset format is a final result of similarity computing; if no, determine that the sample of the preset format is not a final result of similarity computing, and trigger a combining or splitting module;
the combining or splitting module, configured to combine or split the sample of the preset format according to heartbeat information of the similarity computing node to obtain multiple subtask packets, wherein the heartbeat information is used to monitor and describe an idle computing power of the similarity computing node; and
an allocating module, configured to allocate the multiple subtask packets obtained by the combining or splitting module to each similarity computing node respectively.

6. The system according to claim 5, wherein:
the combining or splitting module is specifically configured to obtain statistics on key data indicators of the converted original sample packet and the sample of the preset format, sort the converted original sample packet and the sample of the preset format according to configuration file registration information and the key data indicators, and combine or split the packet of the converted original sample and the sample of the preset format according to sorting order to obtain multiple subtask packets.

7. The system according to claim 5, wherein the control node further comprises:
a heartbeat information monitoring module, configured to obtain heartbeat information of the similarity computing node at preset intervals or upon receiving a sample of the preset format.

8. The system according to claim 7, wherein:
the control node is further configured to save and record the samples of the preset format, record mapping relationships between the multiple subtask packets and the similarity computing nodes to which the subtask packets are allocated, and record the heartbeat information of the similarity computing nodes.

9. The system according to claim 7, wherein:
the heartbeat information monitoring module is further configured to: if the similarity computing node returns no heartbeat information within a preset duration and keeps returning no heartbeat information for more than a preset number of consecutive times, mark the similarity computing node as crashed, mark subtask packets active on the similarity computing node as failed, and trigger the allocating module to allocate the subtask packets marked as failed to uncrashed and idle similarity computing nodes according to the heartbeat information of the similarity computing node.

10. A method for processing similar emails, comprising:
receiving an original sample and a sample of a preset format, and converting the received original sample into the preset format;
determining whether a converted original sample packet and the sample of the preset format are a final result of similarity computing;
if not, combining or splitting the converted original sample packet and the sample of the preset format according to a preset criterion to obtain multiple subtask packets; and
computing a similarity relationship for a sample in each subtask packet to obtain an intermediate similarity computing result which is a sample of the preset format, and feeding back the sample of the preset format, wherein the intermediate similarity computing result comprises at least a unique similar sample, a similarity relationship, and similarity count of the unique similar sample.

11. The method according to claim 10, wherein the receiving an original sample and a sample of a preset format comprises:
collecting emails on a server or a server cluster of a similar email processing system, using the emails as original samples, and allocating task identifiers to the original samples; and
determining whether a task participated in by a sample of the preset format is complete according to the task identifier of the sample of the preset format; if not, aggregating the sample of the preset format with other samples of the task participated in.

12. The method according to claim 10, wherein the determining whether a packet of the converted original sample and the sample of the preset format are a final result of similarity computing comprises:
determining whether the converted original sample packet meets preset conditions; if the converted original sample packet meets the preset conditions, determining that the converted original sample packet is a final result of similarity computing; if the converted original sample packet does not meet the preset conditions, determining that the converted original sample packet is not a final result of similarity computing; and
determining whether the sample of the preset format meets preset conditions; if the sample of the preset format meets the preset conditions, determining that the sample of the preset format is a final result of similarity computing; if the sample of the preset format does not meet the preset conditions, determining that the sample of the preset format is not a final result of similarity computing.

13. The method according to claim 10, wherein the combining or splitting the converted original sample packet and the sample of the preset format according to a preset criterion to obtain multiple subtask packets comprises:
obtaining statistics on key data indicators of the converted original sample packet and the sample of the preset format, sorting the packet of the converted original sample and the sample of the preset format according to configuration file registration information and the key data indicators, and combining or splitting the packet of the converted original sample and the sample of the preset format according to sorting order to obtain multiple subtask packets.

14. The method according to claim 10, wherein:
if the sample of the preset format has undergone similarity computing for at least one time and a local server stores at least two samples of the preset format returned by a task participated in by the sample of the preset format, a combining action needs to be performed for the at least two samples of the preset format returned by the task participated in by the sample of the preset format.

15. The method according to claim 10, wherein the preset criterion comprises at least any one of the following:
splitting the packet of the converted original sample if number of records in the packet of the converted original sample or a total number of bytes in the packet exceeds a preset threshold; and
splitting the sample of the preset format if number of records in the sample of the preset format or a total number of bytes in the sample which is packetized exceeds a preset threshold.
